(19) United States
(12) Patent Application Publication
(10) Pub. No.: US 2011/0094992 A1
(43) Pub. Date: Apr. 28, 2011

(54) Method for Producing a Heat Exchanger

(76) Inventors: Eugen Bilcai, Oberschleissheim (DE); Andrea Ferrari, Duesseldorf (DE)

(21) Appl. No.: 12/854,212

(22) Filed: Aug. 11, 2010

Related U.S. Application Data
(63) Continuation of application No. PCT/EP2009/051713, filed on Feb. 13, 2009.

(30) Foreign Application Priority Data
Feb. 14, 2008 (DE) 102008009371.8

(51) Int. Cl. C23F 1/02; B32B 37/02; B32B 37/06; B32B 37/12

(52) U.S. Cl. 216/34; 156/275.3; 156/273.3

(57) ABSTRACT

Method for manufacturing a heat exchanger, wherein two neighboring metal tubes (1) are joined to one another in the overlap areas at their open ends by a U-shaped end tube (3), using an adhesive (5), wherein
a) the adhesive is applied to the overlap areas of the U-shaped end tube, and wherein the adhesive is selected so that after being applied to the overlap areas of the U-shaped end tube and before being bonded to the metal tubes, the adhesive is solid and not tacky at temperatures below 30° C. and does not cure without an activation step,
b) the end tube with the overlap area and the adhesive applied thereto is attached to the metal tubes or inserted into the metal tubes, and
c) the adhesive is activated thermally or by bombardment with high-energy radiation either before or after step b), so that it cures after step b) and bonds the metal tube to the U-shaped end tube in the overlap area.

This application is a continuation of International Application No. PCT/EP2009/051713 filed Feb. 13, 2009 which claims the benefit of German Patent Application No. 10 2008 009 371.8 filed Feb. 14, 2008.

The present invention relates to a method for producing a heat exchanger, where the term “production” also includes the repair and maintenance of a used heat exchanger with the aid of the inventive method steps. The invention relates to the connection of pipelines for the heat transfer medium by adhesive bonding. At least one of the pipe (tube) ends to be joined adhesively is coated in its overlap region with an adhesive, which is solid and not tacky at room temperature and which does not cure without an activation step. The pipe (tube) segments precoated with adhesive in this way may be shipped and stored without any loss of functionality of the adhesive layer. The adhesive only cures after an activation step, which is performed immediately before or after joining the pipe (tube) segments.

FIG. 1 shows the schematic design of a heat exchanger, which can be produced by the inventive method. This illustration is taken from the document JP 2006/194543. This heat exchanger comprises metallic pipe (tube) segments (1), which are joined together by cooling fins (lamellae) (2) running perpendicular to the pipe (tube) segments. Open ends of neighboring metal pipes (tubes) (1) are joined together by U-shaped end pipes (tubes), using a liquid heat-curing adhesive according to the document cited. A similar method specifically for joining aluminum and copper pipes (tubes) is described in JP 2006/138468.

FIG. 2 shows in greater detail how the adhesive bonding of the U-shaped end pipes (tubes) (3) to the metal pipes (tubes) (1) may be accomplished. In this embodiment, the end pieces (4) of the metal pipes (tubes) (1) are widened. The U-shaped end pipe (tube) is inserted into these widened end pieces of the metal pipes (tubes) (4), and an adhesive (5) is introduced into the resulting gap between the widened end piece (4) and the U-shaped end pipe (tube) (3). According to the document GB 2008462, from which FIG. 2 has been taken, this is evidently done immediately before joining the two parts. A thermally curing epoxy adhesive is typically used as the adhesive. In this case, the metal pipes (tubes) (1) and the U-shaped end pipes (tubes) (3) are both made of aluminum. To improve adhesive power and corrosion protection, it is additionally proposed that the aluminum surfaces be subjected to a corrosion treatment prior to application of the adhesive in order to prevent uncontrolled formation of oxides.

The application of a liquid adhesive in the production area of the heat exchanger has the disadvantage that special application systems must be made available for this purpose. Malfunctioning of the application systems may lead to soiling of workpieces and the working area with adhesive. The present invention proposes a solution to this problem.

The subject matter of the present invention is a method for producing a heat exchanger, having heat exchanger fins (lamellae) (2) and essentially parallel metal pipes (tubes) (1) in thermal contact therewith, such that the metal pipes (tubes) are arranged essentially perpendicularly to the fins (lamellae) and have open ends, and two neighboring metal pipes (tubes) are joined to one another at their open ends by a U-shaped end pipe (tube) (3) in overlap regions using an adhesive, which fills up a gap in the overlap region between the metal pipe (tube) and the U-shaped end pipe (tube), wherein:

a) the adhesive is applied to the overlap regions of the U-shaped end pipe (tube), and wherein the adhesive is selected so that after being applied to the overlap regions of the U-shaped end pipe (tube) and before joining them to the metal pipes (tubes), the adhesive is solid and non-tacky at temperatures below 30° C. and does not cure without an activation step,
b) the end pipe (tube) with the overlap region and the adhesive applied thereto is put onto the metal pipes (tubes) or inserted into the metal pipes (tubes), and
c) the adhesive is activated thermally or by bombarding with high-energy radiation before or after step b), so that it cures after step b) and joins the metal pipe (tube) to the U-shaped end pipe (tube) in the overlap region.

A heat exchanger such as that diagramed schematically in FIG. 1, for example, can be produced by this method. FIG. 2 shows one of the possible embodiments, illustrating how the connection between the U-shaped end pipe (tube) (3) and the metal pipes (tubes) (1) may be designed after joining, activating and curing the adhesive (5).

The difference in comparison with the prior art described in the introduction is that the adhesive is not applied in liquid form in the area of the overlap of the two joined parts immediately before joining the metal pipe (tube) and the end pipe (tube) and the adhesive is not liquid when these parts are joined. Instead, before joining the two parts, the adhesive is applied to the overlap regions of the U-shaped end pipe (tube) in a form such that it is in a solid and non-tacky form when the U-shaped end pipe (tube) is put onto or inserted into the metal pipes (tubes). According to this method, it is possible to apply the adhesive on-site where the U-shaped end pipes (tubes) are produced and to ship and store end pipes (tubes) precoated with the adhesive. The adhesive may thus be applied centrally at the place of manufacture of the U-shaped end pipes (tubes) and need no longer be applied decentrally at the sites of assembly of the complete heat exchangers. This greatly simplifies the entire production process.

The feature whereby the adhesive should be “solid” is to be understood as meaning that it has at least a viscosity, such that it does not flow under the influence of gravity and is not deformed in normal handling of the U-shaped end pipes (tubes) for packaging and shipping.

The feature of being “not tacky” means that the adhesive does not feel tacky when touched with a finger and does not adhere to packaging material or to other precoated U-shaped end pipes (tubes). This and the aforementioned feature make it possible either to package the U-shaped end pipes (tubes) pretreated with adhesive or to ship them as loose goods.

To apply the adhesive to the U-shaped end pieces, the adhesive must at least be spreadable. This can be achieved, for example, by heating an adhesive that is solid at temperatures below 30° C., until it becomes spreadable and can be applied by pressing it out of a nozzle, for example. On cooling to a temperature below 30° C., the adhesive returns to the solid state as defined above. In the case of thermally activatable adhesives, the application temperature must of course not be higher than the activation temperature. In the case of radiation-curing adhesives, there is no such restriction with regard to the application temperature. In addition, the adhesive may be applied as a spreadable paste containing water or solvent. After evaporating the water and/or solvent, it is converted to the desired solid state.

Curing of the adhesive is triggered by an activation step. As long as this step does not occur, the adhesive does not cure, so it does not lose its adhesive power during shipping or storage of the precoated U-shaped end pipes (tubes). The activation step may consist of bombarding with high-energy radiation or heating the adhesive to an adhesive-specific curing temperature.

High-energy radiation is understood to be UV radiation or electron radiation, for example. UV radiation is preferred because of the lower equipment complexity. The input of heat for thermal activation may be accomplished, for example, by irradiation with UV radiation, by the action of hot air, by placing the parts in a heating oven or by heating the metallic joining parts in the area of the adhesive coating through electromagnetic induction. After activation, the adhesive cures in the overlap region, thereby joining the metal pipe (tube) to the U-shaped end pipe (tube).

The inventive method is suitable for conventional metals from which the metal pipes (tubes) and the U-shaped end pipes (tubes) are usually fabricated in heat exchanger construction. These include in particular copper and/or copper alloys as well as aluminum and/or aluminum alloys. The following material combinations are possible:

2a) metal pipes (tubes) and U-shaped end pipes (tubes) consist of copper or a copper alloy,
2b) metal pipes (tubes) and U-shaped end pipes (tubes) consist of aluminum or an aluminum alloy,
2c) metal pipes (tubes) consist of copper or a copper alloy and U-shaped end pipes (tubes) consist of aluminum or an aluminum alloy,
2d) metal pipes (tubes) consist of aluminum or an aluminum alloy and U-shaped end pipes (tubes) consist of copper or a copper alloy.

If the U-shaped end pipes (tubes) consist of aluminum or an aluminum alloy, they may be subjected to a chemical surface treatment at least in the overlap region before applying the adhesive. For details, reference is made to the discussion in the document GB 2008462 cited above. Instead of the chromating used there, however, a chromium-free conversion method is preferred for environmental reasons, for example, treatment of the aluminum surfaces with an aqueous acid solution of complex fluorides of at least one of the elements B, Si, Ti, Zr. For example, processes such as those proposed in EP 754 251 or in the prior art cited in the introduction may be used for this.

FIG. 3 shows one possible embodiment of the present invention. It is provided here that the U-shaped end pipe (tube) (3) is put onto the metal pipes (tubes) (1) in such a way that the metal pipe (tube) is inside the U-shaped end pipe (tube) in the overlap region. In this case, the adhesive (5) is applied to the inside of the U-shaped end pipe (tube) in the overlap region in step a). The U-shaped end pipe (tube) is preferably widened in the overlap region, so that it can be pushed over the metal pipe (tube) together with the adhesive layer without constricting the flow cross section in the metal pipe (tube) and in the U-shaped end pipe (tube).

FIG. 4 shows an example of an alternative embodiment in which the U-shaped end pipe (tube) (3) is inserted into the metal pipe (tube) (1) so that the U-shaped end pipe (tube) (3) is situated inside the metal pipe (tube) (1) in the overlap region. In this case, the adhesive is applied to the U-shaped end pipe (tube) on the outside in the manner of a cuff (5) in the overlap region. In this case, as shown in FIG. 4, the metal pipe (tube) is preferably widened in the overlap region, so that the U-shaped end pipe (tube) can be inserted together with the adhesive layer into the metal pipe (tube) without constricting the flow cross section in the metal pipe (tube) and in the U-shaped end pipe (tube). After activation and curing of the adhesive, an arrangement like that shown in FIG. 2 is obtained.

Depending on the activation mechanism, the adhesive may be activated before joining the two pipes (tubes) or after joining them. For example, one embodiment of the present invention consists of using an adhesive, which can be activated as defined above by irradiation with a high-energy radiation, and then activating the adhesive immediately before step b) by irradiation with high-energy radiation. Curing is then performed after joining the two joining parts, without any further radiation influence.

On the other hand, it is preferable with thermally activatable adhesives to first join the two joining parts and then to heat them, so that the adhesive cures. It was explained above how the heating may take place.

In a preferred embodiment, regardless of the activation mechanism, an adhesive which increases its volume by at least 5% after the activation step is used. In this case, the adhesive contains a physically or chemically acting blowing agent, which is activated on activation of the adhesive itself and which increases the volume of the adhesive due to the formation or expansion of gas. In the case of blowing agents which act physically, the increase in volume is a physical result of heating of hollow microbeads filled with gas or vaporizable liquid. In the case of chemical blowing agents, a gas which causes the increase in the volume of the adhesive is split off by a chemical reaction.

Because of the increase in volume after activation, it is not necessary for the adhesive-precoated U-shaped end pipe (tube) to be inserted with an accurate fit into the metal pipe (tube). Instead, there may remain an air gap between the adhesive and the wall of the metal pipe (tube), which facilitates the joining of the two pipe (tube) parts. Because of the increase in volume, the adhesive fills up this air gap after being activated and thereby bonds the two joining parts in a force-locking manner.

Suitable blowing agents are known in the prior art, e.g., the “chemical blowing agents” which are released by decomposition of gases or “physical blowing agents” i.e., expanding hollow beads. Examples of the first type of blowing agents include azobisisobutyronitrile, azodicarbonamide, dinitrosopentamethylenetetramine, 4,4′-oxybis(benzenesulfonic acid hydrazide), diphenylsulfone-3,3′-disulfohydrazide, benzene-1,3-disulfohydrazide, p-toluenesulfonyl semicarbazide. However, the expandable hollow plastic microbeads based on polyvinylidene chloride copolymers or acrylonitrile/(meth)acrylate copolymers are preferred and are available under the names Dualite and Expancel from the companies Pierce & Stevens and/or Casco Nobel, for example.

In the embodiment of use of an adhesive which expands after activation as described above, it is not necessary for the adhesive to be liquefied during or after activation to completely fill up the adhesive joint between the metal pipe (tube) and the U-shaped bent end pipe (tube). In an alternative embodiment, however, it is possible to proceed in such a way that a blowing agent is omitted and instead an adhesive is used which is first (i.e., before it sets up) melted, i.e., liquefied during the activation step without thereby resulting in an increase in volume beyond the usual thermal expansion. This embodiment may preferably be selected when the activation of the adhesive occurs only after the parts are joined. During the joining, the adhesive is still solid. The melting, i.e., liquefaction, after the joining parts have been joined together results in bridging of the adhesive joint by the adhesive due to capillary forces. It then cures in this state, establishing a force-locking connection between the metal pipe (tube) and the end pipe (tube), which is bent in a U shape. The melting, i.e., liquefaction, takes place due to heat input, for which the heating options mentioned above are available.

An adhesive based on polyurethanes, epoxy resins or acrylates may be used for the inventive method, where the term “acrylate” includes substituted acrylates such as methacrylate.

Examples of adhesives which may be used within the scope of the present invention include so-called “reactive hot-melt adhesives.” These are spreadable in the molten state, so that in this state they can be applied to the U-shaped end pipes (tubes) in the overlap region without activating the curing mechanism. This instead requires heating to a higher activation temperature at which a latent curing agent for a reactive binder component (for example, a prepolymer having epoxy or isocyanate groups) is activated.

When (average) molecular weights of polymers are given below, they refer to the number-average molecular weight M_{N} which can be determined by GPC.

For example, a reactive hot-melt adhesive, which is described in greater detail in EP 354 498 A2, is suitable. This contains a resin component, at least one thermally activatable latent curing agent for the resin component and optional accelerators, fillers, thixotropy aids and other conventional additives, such that the resin component is obtainable by reaction of an epoxy resin that is solid at room temperature, an epoxy resin that is liquid at room temperature, and a linear polyoxypropylene with amino end groups. The epoxy resins are used in an amount, based on the polyoxypropylene with amino end groups, such that an excess of epoxy groups, based on the amino groups, is ensured. For example, dicyanodiamide is suitable as a latent curing agent. For further details, reference is made to the document cited. More specific embodiments of such a reactive adhesive are disclosed in WO 93/00381. These are also suitable within the scope of the present invention.

In addition, epoxy resin structural adhesives such as those described in greater detail in WO 00/37554 may also be used. These are compositions which contain a) a copolymer having at least a glass transition temperature of −30° C. or lower and groups that are reactive with epoxides or a reaction product of these copolymers with a polyepoxide, b) a reaction product of a polyurethane prepolymer and a polyphenol or aminophenol, and c) at least one epoxy resin. To make these compositions heat curable, they additionally contain a latent curing agent from the group of dicyanodiamide, guanamines, guanidines, aminoguanidines, solid aromatic diamines and/or curing accelerators. In addition, they may also contain plasticizers, reactive diluents, rheology aids, fillers, wetting agents and/or antiaging agents and/or stabilizers. Reference is made to the document cited for further details and specific examples.

In addition, heat-curing hot-melt adhesives based on epoxy resin and having the following composition may be used for the inventive method (amounts in parts by weight):

| | Amount used |
|---|---|
| Raw material | (parts by weight) |
| Epoxy resin | 450 |
| Mineral fillers (silicates and carbonates) | 360 |
| Nitrile polymer rubber | 10 |
| Curing agent/accelerator (dicyanodiamide, | 30 |
| epoxy resin-amine adduct) | |
| Expandable hollow microbeads based on acrylate | 25 |

The thermally activatable adhesive systems mentioned above as an example may be formulated with or without the blowing agents also described above, depending on whether or not an increase in volume of the adhesive during and/or after the thermal activation is desired.

The examples cited above concern thermally activatable adhesives, which are preferably activated by heating after joining the adhesive-coated U-shaped end pipe (tube) and the metal pipes (tubes). As an alternative to this, adhesives and in particular hot-melt adhesives containing radiation-polymerizable reactive groups may be used for this purpose. These may be activated by irradiating them with electron radiation or preferably UV radiation before joining these components.

One example of this is a hot-melt adhesive containing more than 30%, based on the hot-melt adhesive, of at least one polyurethane polymer containing at least one radiation-polymerizable reactive group, produced by reacting
A) a reactive PU prepolymer having two or three NCO groups per molecule, prepared from
   i) at least one di- or trifunctional polyol selected from polyethers, polyesters, polyolefins, polyacrylates or polyamides having a molecular weight between 200 and 50,000 g/mol, reacted with
   ii) an excess of at least one di- or triisocyanate having a molecular weight of less than 1000 g/mol,
B) 20 to 95 mol % of at least one low-molecular compound (B) containing a radically polymerizable double bond and a group reacting with an NCO group, and
C) 1 to 50 mol % of at least one compound (C) which has a group reactive with NCO groups but does not have any group polymerizable under radical conditions, having a molecular weight of 32 to 5000 g/mol, and
D) 5 to 50 mol % of at least one radical photoinitiator (D) having a primary or secondary OH group,
where the amounts given are based on the NCO groups of the PU prepolymer, and the sum of B, C and D should yield 100 mol %,
as well as optionally other additives.

This hot-melt adhesive which may be used according to the present invention consists essentially of a PU polymer having radiation-crosslinkable reactive double bonds in terminal position. In addition, the PU polymer should have free non-crosslinkable polymer chain ends. In addition, chemically bound initiators may be present on the PU polymer. The PU polymer should be synthesized from an NCO-reactive polyurethane prepolymer.

The polyurethane prepolymer A) as the basis for further reactions is synthesized by reacting diols and/or triols with di- or triisocyanate compounds. The quantity ratios are selected to yield NCO-functionalized prepolymers in terminal position. In particular the prepolymers should be linear, i.e., should be synthesized primarily from diols and diisocyanates. Additional use of small amounts of trifunctional polyols or isocyanates is possible. Those skilled in the art are familiar with the polyols and polyisocyanates that may be used in the synthesis of these prepolymers.

These are the monomeric di- or triisocyanates known for adhesive applications. Examples of suitable monomeric polyisocyanates include 1,5-naphthylene diisocyanate, 2,2′-, 2,4 and/or 4,4′-diphenylmethane diisocyanate (MDI), hydrogenated MDI (H12MDI), allophanates of MDI, xylylene diisocyanate (XDI), tetramethylxylylene diisocyanate (TMXDI), 4,4′-diphenyldimethylmethane diisocyanate, di- and tetraalkylene diphenylmethane diisocyanate, 4,4′-dibenzyl diisocyanate, 1,3-phenylene diisocyanate, 1,4-phenylene diisocyanate, the isomers of toluoylene diisocyanate (TDI), 1-methyl-2,4-diisocyanatocyclohexane, 1,6-diisocyanato-2,2,4-trimethylhexane, 1,6-di isocyanato-2,4,4-trimethylhexane, 1-isocyanatomethyl-3-isocyanato-1,5,5-trimethylcyclohexane (IPDI), chlorinated and brominated diisocyanates, phosphorus-containing diisocyanates, 4,4′-diisocyanatophenyl perfluoroethane, tetramethoxybutane 1,4-diisocyanate, butane 1,4-diisocyanate, hexane 1,6-diisocyanate (HDI), dicyclohexylmethane diisocyanate, cyclohexene 1,4-diisocyanate, ethylene diisocyanate, phthalic acid bisisocyanatoethyl ester, trimethylhexamethylene diisocyanate, 1,4-diisocyanatobutane, 1,12-diisocyanatododecane, dimeric fatty acid diisocyanate. Especially suitable are aliphatic isocyanates, such as hexamethylene diisocyanate, undecane-, dodecamethylene diisocyanate, 2,2,4-trimethylhexane 2,3,3-trimethylhexamethylene, 1,3- or 1,4-cyclohexane diisocyanate, 1,3- or 1,4-tetramethylxylol diisocyanate, isophorone diisocyanate, 4,4-dicyclohexylmethane, lysine ester diisocyanate or tetramethylxylylene diisocyanate (TMXDI).

Suitable trifunctional isocyanates include polycyanates obtained by trimerization or oligomerization of diisocyanates or by reaction of diisocyanates with polyfunctional compounds containing hydroxyl groups or amino groups. Isocyanates suitable for synthesis of trimers include the diisocyanates already mentioned above, but the trimerization products of HDI, TMXDI or IPDI are especially preferred.

The amount of aromatic isocyanates should preferably be less than 50% of the isocyanates. Especially preferred are PU prepolymers based on aliphatic or cycloaliphatic polyisocyanates or oligomers based on HDI, IPDI and/or 2,4′- or 4,4′-diisocyanateodicyclohexylmethane.

The known polyols having a molecular weight of up to 50,000 g/mol may be selected as difunctional or trifunctional polyols. They should be selected on the basis of polyethers, polyesters, polyolefins, polyacrylates or polyamides, for example, such that these polymers must have additional OH groups. Polyols having terminal OH groups are preferred.

Polyesters that are suitable as the polyol for synthesis of the PU prepolymer can be obtained by polycondensation of acid and alcohol components, in particular by polycondensation of a polycarboxylic acid or a mixture of two or more polycarboxylic acids and a polyol or a mixture or two or more polyols. Suitable polycarboxylic acids include those having an aliphatic, cycloaliphatic, aromatic or heterocyclic base body. Instead of the free carboxylic acids or their acid anhydrides, their esters with C₁₋₅ monoalcohols may optionally also be used for polycondensation.

A variety of polyols may be used as diols for the reaction with the polycarboxylic acids. For example, aliphatic polyols with two to four primary or secondary OH groups per molecular and two to twenty carbon atoms are suitable. Likewise, proportionally higher-functional alcohols may also be used. Those skilled in the art are aware of processes for synthesis of such polyester polyols and these products are commercially available.

In addition, polyether polyols may be used as the polyol. Polyether polyols are preferably obtained by reacting low-molecular polyols with alkylene oxides. The alkylene oxides preferably have two to four carbon atoms. For example, the reaction products of ethylene glycol, propylene glycol or the isomeric butanediols with ethylene oxide, propylene oxide or butylene oxide are suitable. Reaction products of polyfunctional alcohols such as glycerol, trimethylolethane or trimethylolpropane, pentaerythritol or sugar alcohols with the aforementioned alkylene oxides to form polyether polyols are also suitable. These may also be random polymers or block copolymers. Polyether polyols obtained from the aforementioned reactions and having a molecular weight of approx. 200 g/mol to approx. 20,000 g/mol, preferably from approx. 400 g/mol to approx. 6000 g/mol, are especially suitable.

Also suitable as the polyol are polyacetals having terminal OH groups. Additional polyols may be selected on the basis of polycarbonates or polycaprolactones.

Other suitable polyols may be synthesized on the basis of polyacrylates. These are polymers synthesized by polymerization of poly(meth)acrylic esters. Other copolymerizable monomers may also optionally be present in small amounts. The inventive acrylates should have two OH groups, which may preferably be present in terminal position in the polymer. Those skilled in the art are familiar with such OH-functional polymethacrylates.

Another suitable class of polyols comprises the OH-functionalized polyolefins. Those skilled in the art are familiar with polyolefins, which can be produced in many molecular weights. Such polyolefins based on ethylene, propylene or longer-chain α-olefins as homopolymers or copolymers can be functionalized either by copolymerization of functional group-containing copolymers or by graft reactions. Another possibility is for these basic polymers to be provided with OH-functional groups subsequently by oxidation, for example.

Another class of polyols contains a polyamide backbone. Polyamides are the reaction products of diamines with di- or polycarboxylic acids. Through targeted synthesis, it is possible to introduce terminal OH groups into polyamides.

The polyols suitable for synthesis of the PU prepolymers should have a molecular weight between 200 and 50,000 g/mol. In particular the molecular weight should be less than 30,000 g/mol. In the case of polyether polyols, the molecular weight should be between 200 and 20,000 g/mol, in particular between 400 and 6000 g/mol. In the case of polyester polyols, the molecular weight should preferably be less than 10,000 g/mol, in particular between 600 and 2500 g/mol. Linear polyether polyols, polyester polyols or mixtures thereof are especially suitable.

The reaction of the polyols with the polyisocyanates may take place in the presence of solvents, for example, but it is preferable to work in solvent-free form. To accelerate the reaction, the temperature is usually elevated, for example, between 40° C. and 80° C. To accelerate the reaction, the catalysts customarily used in polyurethane chemistry may be added to the reaction mixture. It is preferable to add dibutyltin dilaurate, dimethyltin dineodecanoate or diazabicyclooctane (DABCO). The quantity should be from approx. 0.001 wt % to approx. 0.1 wt % of the prepolymer.

Prepolymers are preferably synthesized from the aforementioned polyisocyanates and polyols based on polyether diols and/or polyester diols. In particular, mixtures of the two types of polyols should be used in synthesis, for example, with 95 wt % to 55 wt % polyether polyol content. Another special embodiment uses polyether polyols containing at least 50 wt % ethylene oxide units. The resulting reactive PU prepolymers A) are NCO-reactive and have three or preferably two isocyanate groups. These are preferably terminal NCO groups.

In another reaction, the NCO groups are proportionally reacted with compounds B) which have a functional group that can react with isocyanates and as an additional functional group have a double bond, which is crosslinkable by free radical polymerization. These usually have a molecular weight of less than 1500 g/mol.

Examples of such compounds include esters of α,β-unsaturated carboxylic acid with low-molecular alcohols, in particular aliphatic alcohols, which still have one additional OH group in the alkyl radical. Examples of such carboxylic acids include acrylic acids, methacrylic acid, crotonic acids, itaconic acid, fumaric acid semi-esters and maleic acid semi-esters. Corresponding esters of methacrylic acid having OH groups include, for example, 2-hydroxyethyl (meth)acrylamide, 2-hydroxyethyl (meth)acrylate, 2-hydroxypropyl (meth)acrylate, 3-hydroxypropyl (meth)acrylate, 3-hydroxypropyl (meth)acrylamide, N-hydroxyethyl (meth)acrylamide. Reaction products of glycidyl ethers or esters with acrylic acid or methacrylic acid, for example, the reaction products of versatic acid glycidyl esters with acrylic acid or methacrylic acid, adducts of ethylene oxide or propylene oxide onto (meth)acrylic acid, reaction products of hydroxyl acrylates with ε-caprolactone or partial reaction products of polyalcohols such as pentaerythritol, glycerol or trimethylolpropane with (meth)acrylic acid.

The amount of OH-functional compound having radically polymerizable double bonds is selected so that 20 to 95 mol %, in particular 22 to 90 mol %, preferably 25 to 85 mol %, based on the NCO groups of the PU prepolymer, is used. A preferred embodiment uses a mixture of methacrylates and acrylates, where the proportion of acrylates amounts to at least 20 mol %, in particular at least 25 mol % of the mixture.

In addition, the NCO-reactive PU prepolymer is reacted with at least one compound C), which has at least one isocyanate-reactive group but does not have any other group that is polymerizable under radical conditions. Examples of such isocyanate-reactive groups include OH, SH or NHR groups. These compounds C) should have a molecular weight between 32 and 10,000 g/mol, in particular between 40 and 4000 g/mol.

Suitable monofunctional compounds include, for example, alcohols with 1 to 36 carbon atoms such as methanol, ethanol, propanol and higher homologs as well as the corresponding thio compounds. In addition, monohydroxy-functional or monoamino-functional polymers with a molecular weight of less than 10,000 g/mol, in particular 200 to 2000 g/mol, may also be used. Mixtures of low-molecular and polymeric building blocks are also possible. In particular the functional group should be an OH group.

Higher-functional compounds are also suitable. Examples of these include diols, triols or polyols, preferably diols or triols, in particular diols. Suitable compounds include, for example, polyols with 2 to 44 carbon atoms, for example, ethylene glycol, propanediol, butanediol and higher homologs as well as the corresponding thio compounds. The amounts of these polyols are selected, so that there is a molar excess of this reactive functionality with respect to the NCO groups. Chain lengthening of the NCO prepolymers may also be performed, but preferably only one OH group is reacted and free OH groups are obtained. The molecular weight of this higher-functional compound C) should be up to 10,000 g/mol, in particular from 200 to 3000 g/mol. SH or NH polymers may also be used.

The amount of compound that is reacted with NCO groups is selected so that 1 to 50 mol %, based on the NCO groups of the PU prepolymer, is reacted. In one embodiment, the amounts are selected so that the sum of the monofunctional compound C) and the compound having the radiation-reactive groups B) together corresponds to the amount of isocyanate groups. In another preferred embodiment, difunctional NCO-reactive compounds are used, where the amount is selected so that the OH:NCO ratio is from 1.5 to 2.5:1, preferably 1.6 to 2.2:1. In particular, the molar ratio should be 2:1, preferably as a difunctional hydroxy compound.

The reaction methods for reacting the reactive PU prepolymers are known to those skilled in the art. A reaction may take place in a mixture or the components may be reacted one after the other. After the reaction, randomly functionalized PU polymers are obtained.

The PU polymer should have a molecular weight of less than 200,000 g/mol, in particular between 1000 and 100,000 g/mol, preferably between 2000 and 50,000 g/mol, in particular less than 20,000 g/mol. The PU polymer should be essentially free of isocyanate groups, i.e., only traces of unreacted NCO groups should be present after the reaction. The amount should be less than 0.1% (based on the prepolymer), especially preferably less than 0.05%.

A photoinitiator which is capable of initiating a radical polymerization of the olefinically unsaturated double bonds on irradiation with light of a wavelength from approx. 215 nm to approx. 480 nm is used as another essential component of the hot-melt adhesive. Essentially all commercial photoinitiators which are compatible with the inventive hot-melt adhesive, i.e., yield mixtures that are at least largely homogeneous are suitable for this purpose.

For example, these are all Norrish type I fragmenting substances and Norrish type II substances. Examples include photoinitiators of the Kayacure series (manufacturer: Nippon Kayaku), Trigonal 14 (manufacturer: Akzo), photoinitiators of the Irgacure®, Darocure®series (manufacturer: Ciba-Geigy), Speedcure® series (manufacturer: Lambson), Esacure series (manufacturer: Fratelli Lamberti) or Fi-4 (manufacturer: Eastman). Especially suitable of these are Irgacure® 651, Irgacure® 369, Irgacure® 184, Irgacure® 907, Irgacure® 1850, Irgacure® 1173 (Darocure® 1173), Irgacure® 1116, Speedcure® EDB, Irgacure® 784 or Irgacure® 2959 or mixtures of two or more compounds of the group. Also suitable are benzophenone and its derivatives such as Speedcure® MBP, Speedcure® MBB, Speedcure® BMS or Speedcure® BEM, thioxanthone and its derivatives such as Speedcure® ITX, Speedcure® CTX, Speedcure® DETX, 2,4,6-trimethylbenzene diphenylphosphine oxide, which may also be used in mixture with one or more of the aforementioned photoinitiators.

The amount of photoinitiators should be up to 6 wt %, based on the adhesive, in particular between 1 and 4 wt %. In a preferred embodiment, the photoinitiators should initiate the reaction under UVA radiation.

In addition, the hot-melt adhesive may also contain amounts of reactive diluents. Suitable reactive diluents include in particular those compounds having one or more reactive functional groups that are polymerizable by irradiation with UV light or with electron beams.

In particular difunctional or higher-functional acrylate esters or methacrylate esters are suitable. Such acrylate esters or methacrylate esters include, for example, esters of acrylic acid or methacrylic acid with aromatic, aliphatic or cycloaliphatic polyols or acrylate esters of polyether alcohols.

Suitable compounds also include, for example, the acrylic acid esters or methacrylic acid esters of aromatic, cycloaliphatic, aliphatic, linear or branched C₄₋₂₀ monoalcohols or corresponding ether alcohols. Examples of such compounds include 2-ethylhexyl acrylate, octyl/decyl acrylate, isobornyl acrylate, 3-methoxybutyl acrylate, 2-phenoxyethyl acrylate, benzyl acrylate or 2-methoxypropyl acrylate, neopentyl glycol di(meth)acrylate, 1,6-hexanediol di(meth)acrylate, trimethylolpropane tri(meth)acrylate, pentaerythritol tetra(meth)acrylate as well as (meth)acrylate esters of sorbitol and other sugar alcohols. These (meth)acrylate esters of aliphatic or cycloaliphatic diols may optionally be modified with an aliphatic ester or an alkylene oxide. Acrylates modified by an aliphatic ester include, for example, neopentyl glycol hydroxypivalate di(meth)acrylate, caprolactone-modified neopentyl glycol hydroxypivalate di(meth)acrylates and the like. The alkylene oxide-modified acrylate compounds include, for example, ethylene oxide-modified neopentyl glycol di(meth)acrylates, propylene oxide-modified neopentyl glycol di(meth)acrylates, ethylene oxide-modified 1,6-hexanediol di(meth)acrylates or propylene oxide-modified 1,6-hexanediol di(meth)acrylates, neopentyl glycol-modified (meth)acrylates, trimethylolpropane di(meth)acrylates, polyethylene glycol di(meth)acrylates, polypropylene glycol di(meth)acrylates and the like. Trifunctional and higher-functional acrylate monomers include, for example, trimethylolpropane tri(meth)acrylate, pentaerythritol tri- and tetra(meth)acrylate, dipentaerythritol tetra(meth)acrylate, dipentaerythritol penta(meth)acrylate, dipentaerythritol hexa(meth)acrylate, caprolactone-modified dipentaerythritol hexa(meth)acrylate, pentaerythritol tetra(meth)acrylate, tris(meth)acryloxyethyl isocyanurate, caprolactone-modified tris(meth)acryloxyethyl isocyanurates or trimethylolpropane tetra(meth)acrylate, or mixtures of two or more thereof.

Furthermore, photosensitizers may also be used. Through the use of photosensitizers, it is possible to expand the absorption of photopolymerization initiators toward shorter and/or longer wavelengths and in this way to accelerate the crosslinking. The radiation of a certain wavelength absorbed by them is transmitted as energy to the photopolymerization initiator. Photosensitizers which may be used within the scope of the present invention include, for example, acetophenone, thioxanthanes, benzophenone and fluorescein and their derivatives.

For example, such a radiation-curable hot-melt adhesive can be obtained by the following method:

Apparatus: one-liter four-neck flask with a stirrer; thermosensor; N₂ conduction, height-adjustable oil bath; vacuum pump with nitrogen-filled cold trap.

Batch:

| | | |
|---|---|---|
| 1) PPG 1000 | 300.00 | g (polypropylene glycol 1000; |
| | | OH value = 112) |
| 2) IPDI | 78.46 | g (isophorone diisocyanate) |
| 3) DBTL | 0.01 | g (dibutyltin dilaurate) |
| 4) HEA | 3.24 | g (2-hydroxyethyl acrylate) |
| 5) Irgacure 2959 | 12.53 | g (photoinitiator) |
| 6) Polyglycol 01/40 | 30.72 | g (butyl-substituted PPG monoalcohol) |
| 7) Irganox 1726 | 0.76 | g (antioxidant) |

Experimental Procedure:

Substance 1) was placed in the reactor first and heated to approx. 120° C. Then a vacuum was applied and the mixture was dehydrated for one hour at <10 mbar and then flushed with nitrogen. The temperature was lowered to 30° C., substance 3) was added and the mixture was homogenized for 10 minutes. Substance 2) was added next. The temperature was raised to 80° C. in increments. Stirring was continued at this temperature until the NCO value was 1.24%. The batch was flushed, 0.38 g of substance 7) was added and the mixture was homogenized. Then substance 4) was added and stirring was continued at 80° C. until an NCO value of 0.65 was measured. Next, 5) was added and stirring was continued until the NCO value was 0.12%. Then 0.38 g of 7) was stirred into the mixture. 6) was added and stirring was continued until the NCO value was less than 0.02%. The batch was degassed in vacuo and bottled.

### DESCRIPTION OF THE FIGURES

FIG. 1 shows the schematic design of a heat exchanger having metal pipes (tubes) (1), whose ends are bridged by U-shaped end pipes (tubes) (3), so that the heat transfer fluid can flow through metal pipes (tubes) and U-shaped end pipes (tubes). The cooling ribs (2), which are connected to the metal pipes (tubes) to conduct heat, run perpendicular to the metal pipes (tubes) and connect the metal pipes (tubes) to one another.

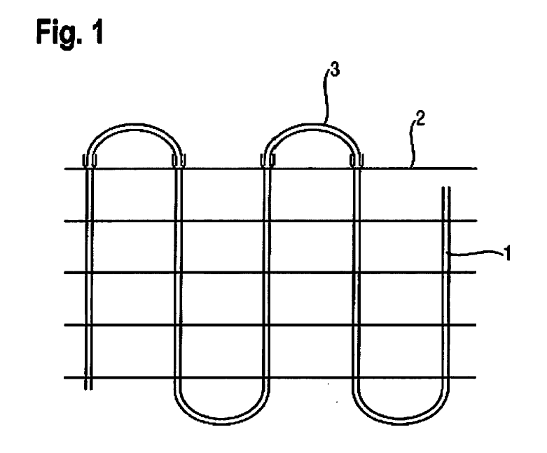

FIG. 2: Enlarged detail of a heat exchanger having a U-shaped end pipe (tube) (3) which bridges two metal pipes (tubes) (1) (only their end pieces are shown here). The metal pipes (tubes) (1) are widened (4) in a bell shape in the overlap region, such that the gap between the bell-shaped widened area and the U-shaped end pipe (tube) is filled by an adhesive (5).

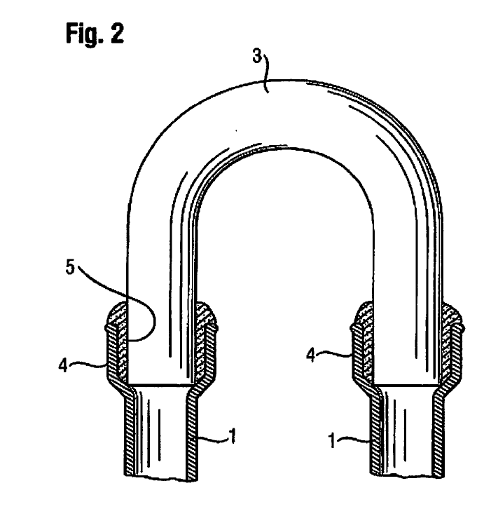

FIG. 3 shows one possible embodiment of the present invention. The U-shaped end pipe (tube) (3) is widened in the overlap region and is coated with an adhesive layer (5) on the inside. For joining, the U-shaped end pipe (tube) (3) is pushed over the metal pipes (tubes) (1) with its overlap region.

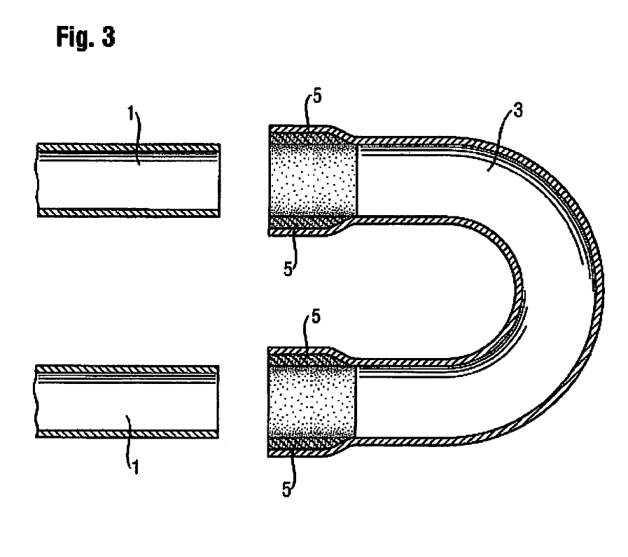

FIG. 4 shows another embodiment of the present invention. In this case, the metal pipes (tubes) (1) are widened in a bell shape in the end area (4). The U-shaped end pipe (tube) (3) is coated on the outside with a layer of the adhesive in the overlap region. The parts are joined by inserting the U-shaped end pipe (tube) (3) with its adhesive-coated overlap region into the widened end part (4) of the metal pipe (tube) (1).

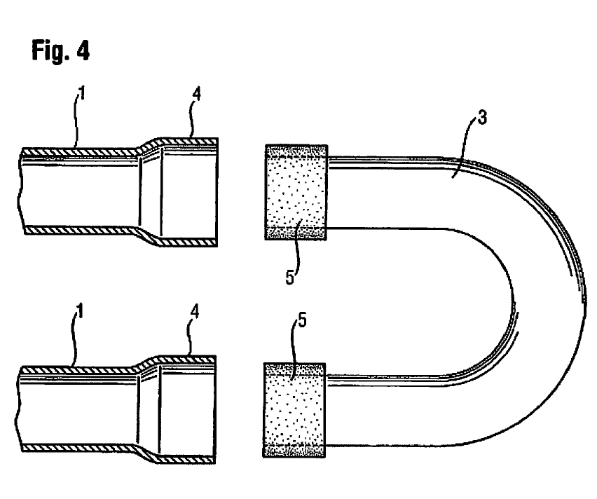

### LIST OF REFERENCE NUMERALS

(1) Metal pipe (tube)
(2) Cooling fins (lamellae) or cooling ribs
(3) U-shaped end pipe (tube)
(4) Widened end areas of the metal pipes (tubes) (1)
(5) Adhesive layer

1. A method for manufacturing a heat exchanger, which has heat exchanger lamellae and essentially parallel metal tubes in thermal contact therewith,
wherein the metal tubes are arranged essentially perpendicular to the lamellae and have open ends and
wherein two neighboring metal tubes are joined together at their open ends by a U-shaped end tube in the overlap areas between the metal tubes and the U-shaped end tube,
wherein an adhesive fills up a gap in the overlap area between the metal tubes and the U-shaped end tube, wherein
a) the adhesive is applied to the overlap areas of the U-shaped end tube and wherein the adhesive is selected so that after application to the overlap areas of the U-shaped end tube and before joining to the metal tubes, the adhesive is solid and not tacky at temperatures below 30° C. and does not cure without an activation step,
b) the end tube with the overlap area and the adhesive applied thereto is attached to the metal tubes or inserted into the metal tubes, and
c) the adhesive is activated thermally or by bombardment with high-energy radiation before or after step b), so that it cures after step b) and bonds the metal tube to the U-shaped end tube in the overlap area.

2. The method according to claim 1, wherein the material of the metal tubes and the U-shaped end tubes corresponds to one of the following combinations:
a) metal tubes and U-shaped end tubes consist of copper or a copper alloy,
b) metal tubes and U-shaped end tubes consist of aluminum or an aluminum alloy,
c) metal tubes consist of copper or a copper alloy and U-shaped end tubes consist of aluminum or an aluminum alloy,
d) metal tubes consist of aluminum or an aluminum alloy and U-shaped end tubes consist of copper or a copper alloy.

3. The method according to claim 2, wherein the U-shaped end tubes consist of aluminum or an aluminum alloy and they are subjected to a chemical surface treatment at least in the overlap area before applying the adhesive.

4. The method according to claim 1, wherein in step b) the U-shaped end tube is attached to the metal tubes, so that the metal tube is situated within the U-shaped end tube in the overlap area, and wherein in step a) the adhesive is applied to the inside of the U-shaped end tube in the overlap area.

5. The method according to claim 1, wherein in step b) the U-shape end tube is inserted into the metal tubes, so that the U-shaped end tube is inside the metal tube in the overlap area, and wherein in step a) the adhesive is applied to the U-shaped end tube on the outside in the overlap area.

6. The method according to claim 1, wherein the adhesive is activatable by bombardment with high-energy radiation, and the adhesive is activated by bombardment with high-energy radiation immediately before step b), so that it cures after step b).

7. The method according to claim 1, wherein the adhesive is thermally activatable and the adhesive is heated after step b) and thereby cured.

8. The method according to claim 1, wherein the adhesive increases its volume by at least 5% after the activation step.

9. The method according to claim 1, wherein the adhesive is molten and/or liquefied during the activation step without any resulting increase in volume.

10. The method according to claims 1, wherein the adhesive is a polyurethane, an epoxy resin or an acrylate adhesive.
